(19) United States
(12) Patent Application Publication
(10) Pub. No.: US 2012/0135642 A1
(43) Pub. Date: May 31, 2012

(54) CONNECTOR AND CONNECTOR ASSEMBLY

(75) Inventor: Wei-Sun Chang, Taipei (TW)

(73) Assignee: BING XU PRECISION CO. LTD., New Taipei City (TW)

(21) Appl. No.: 13/178,503

(22) Filed: Jul. 8, 2011

(30) Foreign Application Priority Data
Nov. 30, 2010 (TW) 99223221

(51) Int. Cl. H01R 24/00; H01R 24/20

(52) U.S. Cl. 439/630; 439/626; 439/660

(57) ABSTRACT

A connector and a connector assembly are provided. The connector assembly includes a board-side connector suitable to be fixed onto a circuit board and a cable connector suitable to assist the circuit board and other devices for electronic signals transmission. The board-side connector has an obliquely guiding path for the cable connector to be obliquely inserted and assembled into the board-side connector. The board-side connector has a first metallic shell, the cable connector has a second metallic shell, and the first metallic shell and the second metallic shell are contacted each other to form an electromagnetic shielding structure, and the board-side connector and the cable connector are held by each other.

### CROSS-REFERENCE TO RELATED APPLICATION

This application claims the priority benefit of Taiwan application serial no. 99223221, filed on Nov. 30, 2010. The entirety of the above-mentioned patent application is hereby incorporated by reference herein and made a part of this specification.

### BACKGROUND OF THE INVENTION

1. Field of the Invention

The present invention generally relates to a connector and a connector assembly, and more particularly, to a connector and a connector assembly used for transmitting power/low-speed signal and/or high-speed signal.

2. Description of Related Art

The prior art, for example, TW Patent No. M371317 filed on Aug. 10, 2009 discloses a SATA connector, referring to FIGS. 13 and 14, which respectively show a 3-dimensional exploded schematic diagram of a conventional SATA connector and a schematic assembly diagram thereof. The conventional SATA connector is composed of a first connector 1 and a second connector 2. The connector 1 includes an insulation body 10, two terminal sets 20 and 30, a ground terminal 37, a cable 40, a metallic shell 50 and a pull band 57. In the diagram, P represents a circuit board. In the prior art, the terminal sets 20 and 30 of the connector 1 are plugged into the connector 2 in vertically inserting way (FIG. 14) with a larger inserting force and the connector 1 is uneasily plugged/unplugged, so that a pull band 57 is employed herein. Moreover, the connector 1 is vertically assembled into the connector 2, the overall thickness of the conventional SATA connector is limited to be reduced and the design needs to be improved.

In addition, since the terminal sets 20 and 30 are bent at a vertically upper place, in which the bending portions with small area serve as soldering places for externally connecting the cable, so that the areas available for soldering operation are small. In particular, the bending design of the terminals would cause an up-down-step during transmitting signals, which easily affects the transmission quality.

### SUMMARY OF THE INVENTION

Accordingly, the present invention is directed to a connector and a connector assembly, in which in comparison with the prior art, the connector and the connector assembly have universality to a greater extent and are used in not only SATA specification, but also an electronic device with different specifications.

According to one aspect of the present invention, it is to provide a connector assembly, comprising a board-side connector suitable to be fixed onto a circuit board and a cable connector suitable to assist the circuit board and other devices for electronic signals transmission. The board-side connector has an obliquely guiding path for the cable connector to be obliquely inserted and assembled into the board-side connector. The board-side connector has a first metallic shell, the cable connector has a second metallic shell, and the first metallic shell and the second metallic shell are contacted each other to form an electromagnetic shielding structure. The board-side connector and the cable connector are held by each other.

According to one aspect of the present invention, it is to provide a connector, which is a board-side connector comprising a first insulation base, a plurality of first terminals and a first metallic shell. The first insulation base has a first foolproof structure and a plurality of first slots. The first terminals are respectively inserted at the first slots and respectively have a protrusive portion protruded from the first slots. The first metallic shell encloses a part of the first insulation base and exposes out the protrusive portions of the first terminals and the portions of the first slots close to the protrusive portions, in which the protrusive portions of first terminals and the first metallic shell together form a guiding path. The first metallic shell of the board-side connector further comprises at least one first contacting portion for electrically connecting a cable connector to form an electromagnetic shielding structure. The first foolproof structure comprises a lengthwise rib or a lengthwise recess.

According to one aspect of the present invention, it is to provide a connector, which is a cable connector comprising a second insulation base, a plurality of second terminals, a plurality of cables and a second metallic shell. The second insulation base has a second foolproof structure and a plurality of second slots. The second terminals are slightly in plate-shape and are disposed at the second slots slightly in co-plane way. The cables are electrically connected to the second terminals. The second metallic shell encloses a part of the second insulation base and exposes out the second terminals.

According to one aspect of the present invention, it is to provide a connector. The connector comprising an insulation base, a power/low-speed signal terminal portion and a high-speed signal terminal portion. The insulation base has an foolproof structure and a plurality of slots located at both sides of the foolproof structure. The power/low-speed signal terminal portion has a plurality of power/low-speed signal terminals and the terminals are inserted at the slots at one side of the foolproof structure. The high-speed signal terminal portion has a plurality of high-speed signal terminals and the terminals are inserted at the slots at the other side of the foolproof structure. The width and pitch of the power/low-speed signal terminals are greater than the width and pitch of the high-speed signal terminals.

According to one aspect of the present invention, it is to provide a connector assembly, comprising a first connector and a second connector. The first connector is, for example, the above-mentioned board-side connector and the second connector is, for example, the above-mentioned cable connector. The first metallic shell of the above-mentioned first connector has at least one first contacting portion and the second metallic shell of the above-mentioned second connector has at least one second contacting portion. The guiding path of the first connector is suitable for the second connector to be obliquely inserted and assembled into, which makes the first terminals electrically connected to the second terminals and the first contacting portion leans against the second contacting portion. In this way, the first metallic shell and the second metallic shell together form an electromagnetic shielding structure, thereby the first connector and the second connector are held by each other.

The present invention has a beneficial effect that by using the guiding path and obliquely inserting design, the cable connector (second connector) can be more handy and easier inserted into the board-side connector and the overall height of the connector assembly after assembling the cable connector (second connector) and the board-side connector (first connector) can be further reduced.

The present invention has a beneficial effect that since the second terminals are slightly in plate-shape and are disposed at the second slots slightly in co-plane way, so that the electrical connection reliability between the second terminals and the cables is advanced, the electrical performance during transmitting signals is more stable and the overall height of the connector assembly can be further reduced.

The present invention has a beneficial effect that the width and pitch of the power/low-speed signal terminals are greater than the width and pitch of the high-speed signal terminals so that the present invention can provide a better electrical performance.

The present invention has a beneficial effect since the connector assembly is completed by using universal terminal structure and cable structure, the connector assembly or the connector assembly accompanied with a combo junction are universally used in the situations with various specifications and become a transmission interface complied with many specifications, in which the transmission object includes power signal, low-speed signal, high-speed signal or combination of the above-mentioned signals.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a 3-dimensional schematic diagram of a connector assembly before assembling according to an embodiment of the present invention.

FIG. 2 is a side-view cross-sectional diagram of FIG. 1.

FIG. 3 is a status diagram after completing the connector assembly of FIG. 1.

FIG. 4 is a status diagram showing a board-side connector is fixed on a circuit board according to an embodiment of the present invention.

FIG. 5 is a 3-dimensional schematic diagram of a cable connector according to an embodiment of the present invention.

FIG. 6 is a 3-dimensional exploded schematic diagram of a board-side connector according to an embodiment of the present invention.

FIG. 7 is a 3-dimensional exploded schematic diagram of a cable connector (without insulation cover) according to an embodiment of the present invention.

FIG. 8 is a schematic diagram showing a second metallic shell is assembled to a second insulation base.

FIG. 9 is a schematic diagram showing an insulation cover is assembled into a cable connector.

FIG. 10 is a 3-dimensional schematic diagram of an insulation cover according to an embodiment of the present invention.

FIGS. 11A-11C are locally enlarged diagrams in different angles of view of part A in FIG. 3, and FIG. 11D is a locally enlarged diagram of part B in FIG. 3.

FIG. 12 is a schematic diagram of a connector assembly accompanied with a combo junction according to an embodiment of the present invention.

FIG. 13 is a 3-dimensional exploded schematic diagram of a conventional SATA connector.

FIG. 14 is a schematic diagram of the assembly of FIG. 13.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

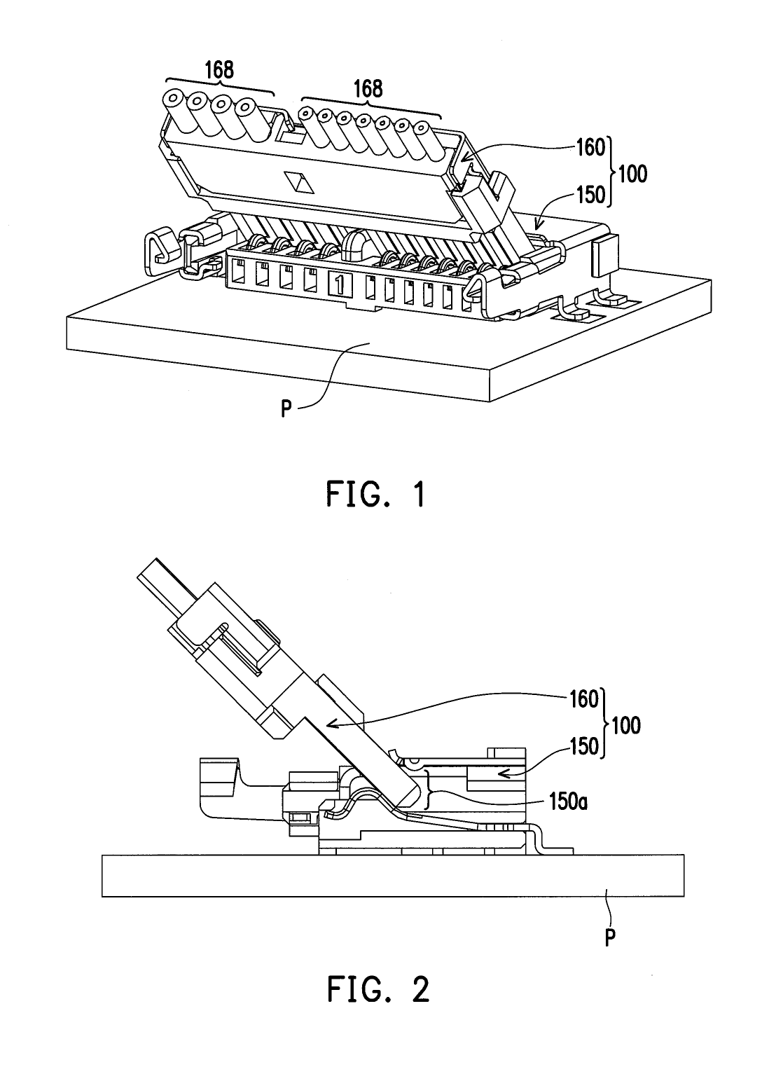

FIG. 1 is a 3-dimensional schematic diagram of a connector assembly before assembling according to an embodiment of the present invention.

The present invention provides a connector assembly 100, which includes a board-side connector 150 and a cable connector 160.

The board-side connector 150 is suitable to be fixed onto a circuit board P, in which the circuit board is, for example, a computer motherboard or a main board of a control circuit in a common electronic device, and that is why the connector is refereed as a board-side connector.

The cable connector 160 is suitable to assist the circuit board P and other devices for electronic signals transmission. One end of the cable connector 160 is connected to the board-side connector 150, while the other end thereof is connected to other electronic devices via cables 168. Based on the above-mentioned feature, the connector assembly 100 can serve as a transmission interface. The transmission object can include power signal, low-speed signal, high-speed signal or combination of the above-mentioned signals. The device connected to the cables 168 can be, for example, one complied with at least one specification of SATA, USB3.0, USB2.0 or eSATA, such as a hard disc drive (HDD), an optical disc drive (ODD), various USB transmission interfaces, various combo transmission interfaces or other electronic devices with the above-mentioned specifications.

### Obliquely Inserted Assembly

Referring to FIG. 2, which is a side-view cross-sectional diagram of FIG. 1.

The board-side connector 150 of the invention has an obliquely guiding path 150a for the cable connector 160 to be obliquely inserted and assembled into the board-side connector 150. By means of the feature, the cable connector 160 can be more handy and easier inserted into the board-side connector 150 and the overall height of the connector assembly after assembling the cable connector 160 and the board-side connector 150 can be further reduced. Each element of the connector assembly is described in follows.

### Electromagnetic Shielding Structure

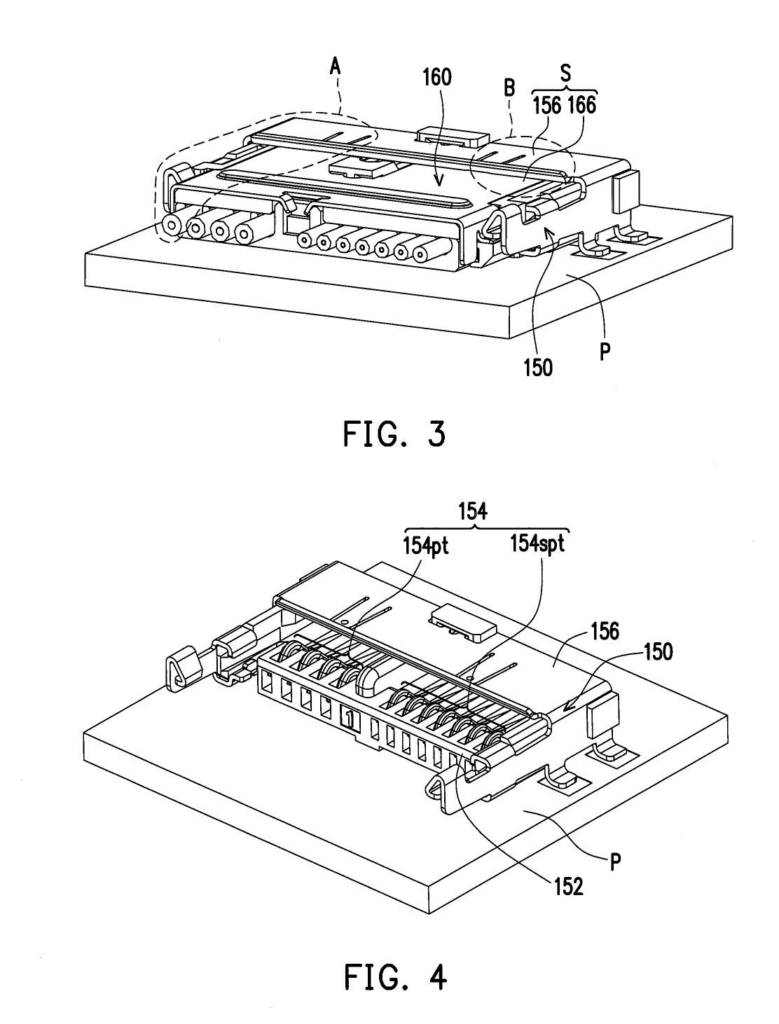

Referring to FIG. 3, which is a status diagram after completing the connector assembly of FIG. 1. The board-side connector 150 has a first metallic shell 156 and the cable connector 160 has a second metallic shell 166. The first metallic shell 156 and the second metallic shell 166 are contacted each other so as to form an electromagnetic shielding structure S. The following describes details of the elements.

### Serving as Transmission Interface

FIG. 4 is a status diagram showing a board-side connector is fixed on a circuit board according to an embodiment of the present invention.

Referring to FIG. 4, the board-side connector 150 has a plurality of first terminals 154, which include at least one power/low-speed signal terminal 154pt and at least one high-speed terminal 154spt. The terminals number in FIG. 4 is an example only, which the present invention is not limited to. In the present invention, ‘/’ represents ‘used in shared way’, for example, the power/low-speed signal terminal 154pt can be used for power signal transmitting, also for low-speed signal transmitting.

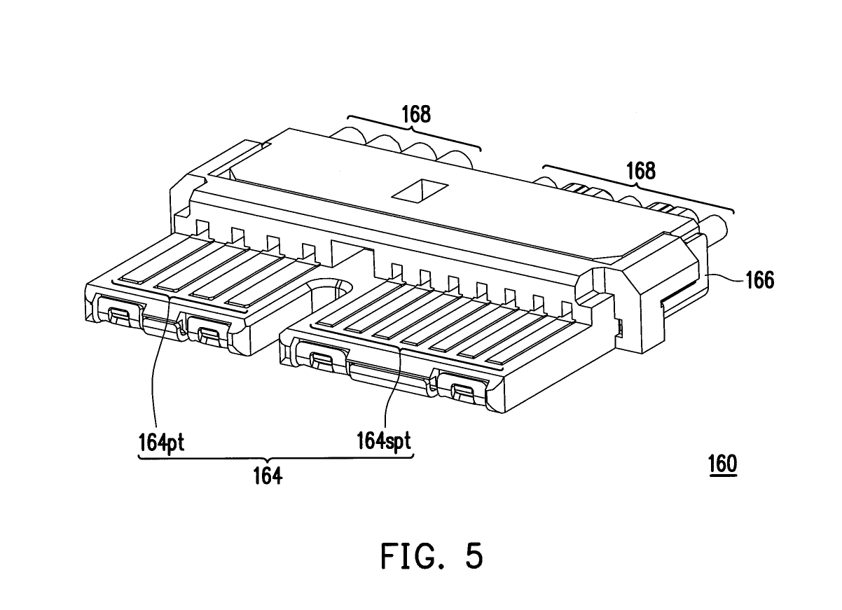

FIG. 5 is a 3-dimensional schematic diagram of a cable connector according to an embodiment of the present invention.

Referring to FIG. 5, the cable connector 160 has a plurality of second terminals 164, which are respectively electrically connected to the power/low-speed signal terminal 154pt and the high-speed terminal 154spt of the board-side connector 150. The second terminals 164 of the cable connector 160 are also electrically connected to the cables 168. The terminals number in FIG. 4 is an example only, which the present invention is not limited to.

The electronic signals transmission content between the circuit board and other electronic devices can roughly be divided into power signal, low-speed signal and high-speed signal, so that the structure herein, after considering several common pin specifications and predetermined expansible margin, is a universal design, by which the terminals of the board-side connector 150 and the cable connector 160 can be universally used in as many specifications as possible, and the cables 168 of the cable connector 160 can be compatible with various specifications. As a result, as long as the terminals numbers of the board-side connector and the terminals numbers of the cable connector (the terminals numbers of the first terminals and the terminals numbers of the second terminals) and the cable number are respectively greater than the terminals number of the electronic device to be connected, a universal connection effect can be achieved by an appropriate connection layout (for example, connecting the cable/cables to the corresponding terminal/terminals).

As described above, the cables 168 are suitable to connect a device complied with at least one specification of SATA, USB3.0, USB2.0 or eSATA, so that the connector assembly of the board-side connector 150 and the cable connector 160 can serve as a transmission interface of power and signal between a circuit board and other devices.

### Planar Soldering Portion Structure

In general speaking, a terminal and a cable are electrically connected to each other through a soldering process. In order to make the electrical connection between a terminal and a cable easier and more reliable, as shown by FIG. 5, the second terminals 164 of the cable connector 160 in the invention are slightly in plate-shape and disposed slightly in co-plane way in the cable connector 160. This design can advance the reliability of electrical connection between a terminal and a cable. Meanwhile, the terminal slightly in plate-shape can also make the electrical performance during transmitting signal more stable and further reduce the overall height of the connector assembly.

The following describes details of the elements of the connector assembly in the present invention.

### Board-Side Connector

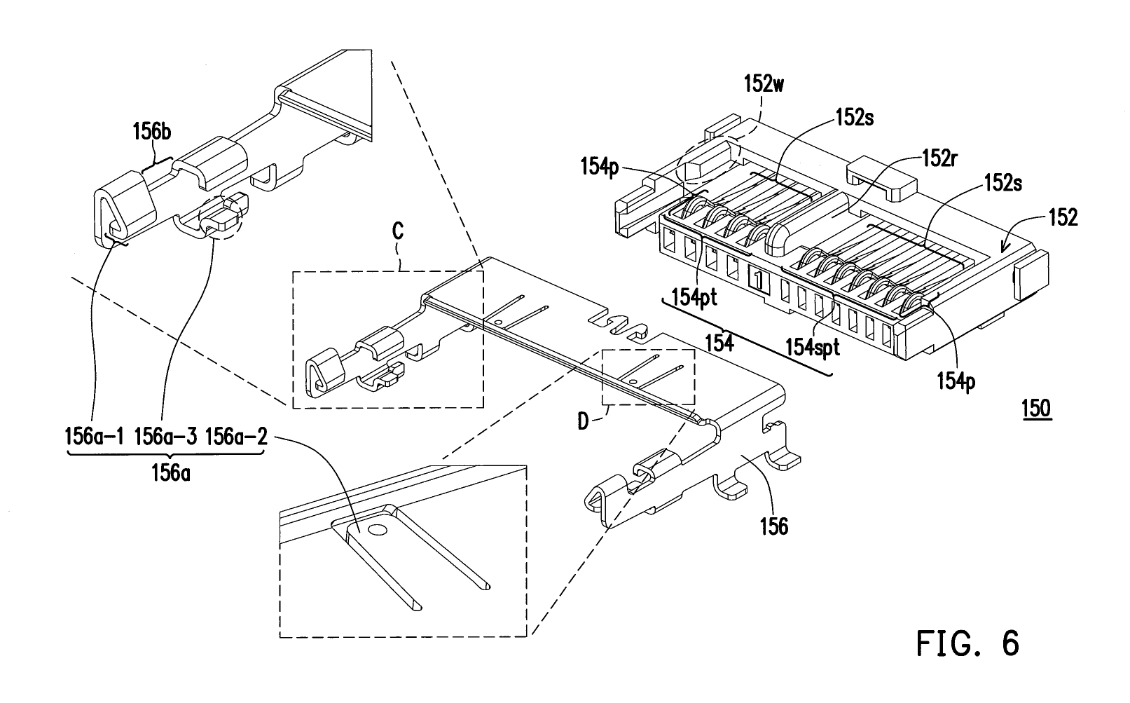

FIG. 6 is a 3-dimensional exploded schematic diagram of a board-side connector according to an embodiment of the present invention.

Referring to FIG. 6, the board-side connector 150 of the invention includes a first insulation base 152, a plurality of first terminals 154 and a first metallic shell 156.

The first insulation base 152 has a first foolproof structure 152r and a plurality of first slots 152s, wherein the first slots 152s are disposed, for example, at both sides of the first foolproof structure 152r.

The first terminals 154 are respectively inserted at the first slots 152s, and each of the first terminals 154 has a protrusive portion 154p protruded from the first slot 152s.

The portions of the first slots 152s close to the protrusive portions 154p respectively have a higher surface. Due to the disposing of the first foolproof structure 152r, the first terminals 154 are also respectively located at both sides of the first foolproof structure 152r, and the terminals of one side are set as the power/low-speed signal terminals 154pt, while the terminals at the other side are set as the high-speed terminals 154spt. In other words, the first foolproof structure 152r partitions the first terminals 154 into the power/low-speed signal terminal 154pt and the high-speed terminal 154spt.

Referring to FIGS. 4 and 6, the first metallic shell 156 encloses a part of the first insulation base 152 and exposes out the protrusive portions 154p of the first terminals 154 and the portions of the first slots 152a close to the protrusive portions 154p, and the protrusive portions 154p of the first terminals 154 and the first metallic shell 156 together form a guiding path 150a (FIG. 2). The guiding path 150a is for guiding the cable connector 160 to be obliquely inserted and assembled into the board-side connector 150. After assembling, the first terminals 154 are electrically connected to the second terminals 164. Two extension arms 152w are disposed at both sides of the first insulation base 152 and connect the first metallic shell 156 as well. During assembling in or pulling out the cable connector 160, the extension arms 152w at both sides of the first insulation base 152 are deformed and produce changing stresses. In order to make the distribution of the produced stresses more even, the thickness of the extension arm 152w is designed in gradually changing form, for example, a slope structure or structures of other curved-surface.

The pin definitions of the power/low-speed signal terminals 154pt of the first terminals 154 include all pin definitions of USB 2.0, pin definition of SATA power terminal or pin definition of eSATA power terminal. The pin definitions of the high-speed terminal 154spt of the first terminals 154 include pin definition of SATA signal terminal, pin definition of USB3.0 signal terminal or pin definition of eSATA signal terminal.

### Cable Connector

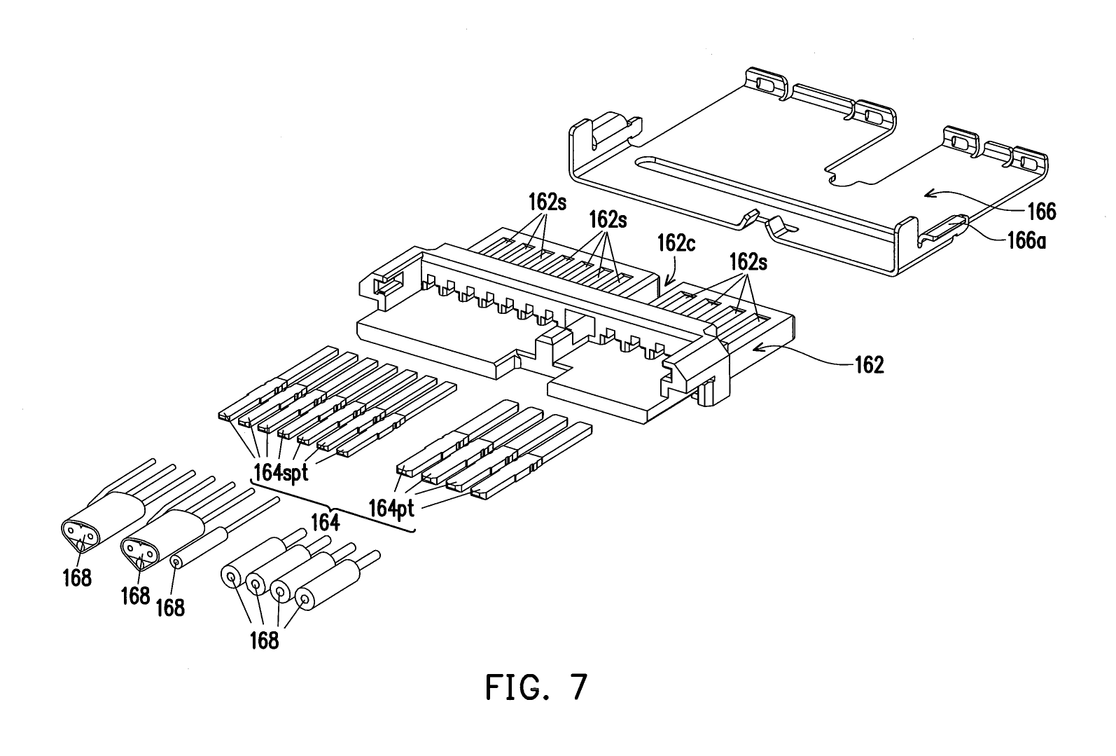

FIG. 7 is a 3-dimensional exploded schematic diagram of a cable connector (without insulation cover) according to an embodiment of the present invention.

Referring to FIG. 7, the cable connector 160 includes a second insulation base 162, a plurality of second terminals 164, a second metallic shell 166 and a plurality of cables 168.

The second insulation base 162 has a second foolproof structure 162c (for example, lengthwise recess) and a plurality of second slots 162s. When the cable connector 160 is inserted into the board-side connector 150, the second foolproof structure 162c is matched with the first foolproof structure 152r, in which they are respectively convex and concave, for example, the first foolproof structure 152r is lengthwise rib and then the second foolproof structure 162c is lengthwise recess suitable for the lengthwise rib to be inserted into. It is not defined which structure must be convex and the other structure must be concave; the important is the two structures are male/female matched with each other for assembling. The second slots 162s are disposed, for example, at both sides of the second foolproof structure 162c.

The second terminals 164 are slightly in plate-shape and disposed slightly in co-plane way at the second slots 162s (FIG. 5). The cables 168 are electrically connected to the second terminals 164.

Due to the disposing of the second foolproof structure 162c, the second terminals 164 are respectively disposed at both sides of the second foolproof structure 162c as well, in which the terminals of one side are set as the power/low-speed signal terminals 164pt, while the terminals at the other side are set as the high-speed terminals 164spt. In other words, the second foolproof structure 162r partitions the second terminals 164 into the power/low-speed signal terminals 164pt and the high-speed terminals 164spt. In FIG. 7, the partial cables 168 corresponding to the high-speed terminal 164spt are differential-signal wire sets, in which a wire set is composed of a pair of a positive-phase signal wires and a negative-phase signal wire plus a ground wire. In FIG. 7, there are two differential-signal wire sets and a ground cable.

Referring to FIGS. 5 and 7, the second metallic shell 166 encloses a part of the second insulation base 162 and exposes out the second terminals 164 (FIG. 5).

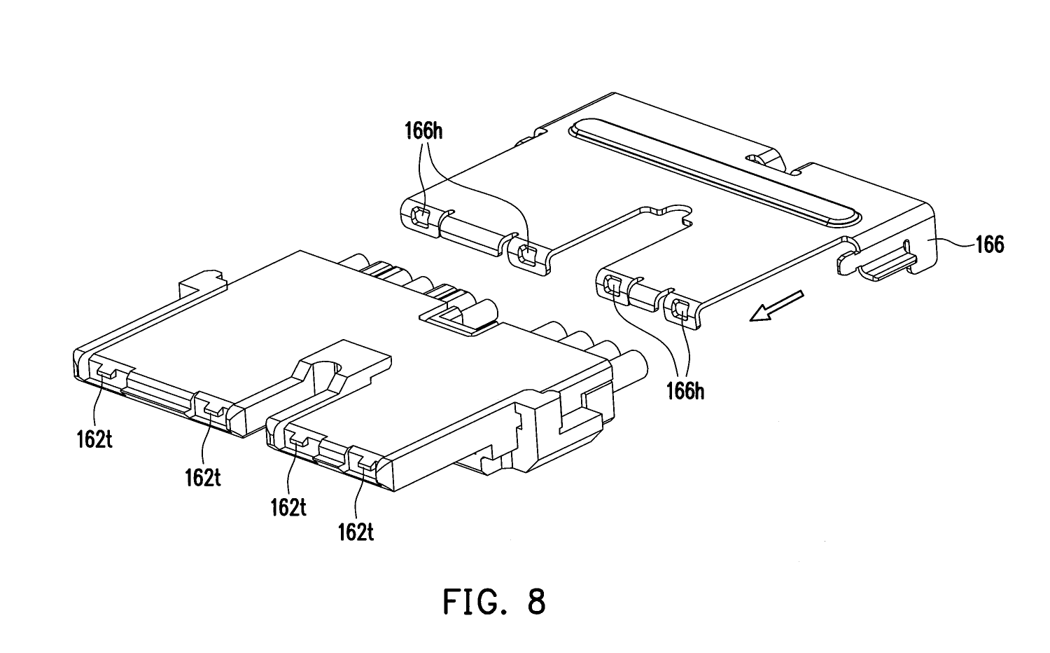

FIG. 8 is a schematic diagram showing a second metallic shell is assembled to a second insulation base, in which the arrow represents an assembling-into direction.

The second metallic shell 166 can be assembled into the second insulation base 162 by fastening each other (FIG. 8). For example, the second insulation base 162 has at least one base tenon 162t and the second metallic shell 166 has a fastening portion 166h (for example, fastening hole), in which the fastening portion 166h is located at a place corresponding to the base tenon 162t so that the base tenon 162t and the fastening portion 166h can be fastened by each other, and the base tenon 162t is located, for example, at the front-end side of the assembling-into direction as shown by the arrow. It should be noted that the assembling-into direction means the direction along which the second metallic shell 166 is assembled into the second insulation base 162. In addition, the portion of the second metallic shell 166 at the front-end side is round-corner shape.

The above-mentioned cables 168 can be common conductive wires wrapped with insulation layers, can include at least one pair of differential-signal wire sets and can be single-core wire or multi-cores wire depending on the design requirement.

### Insulation Cover

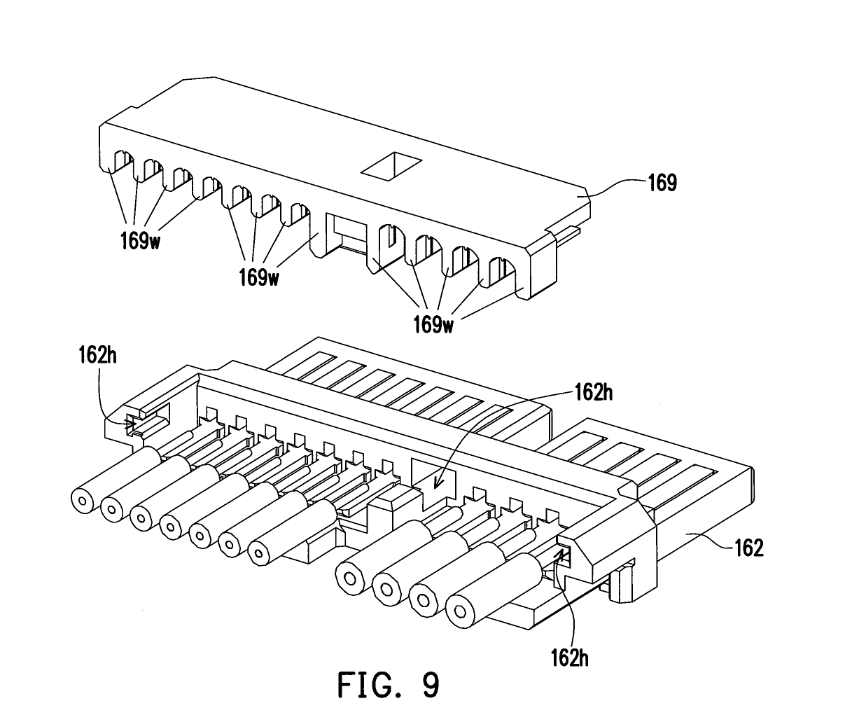

In order to better protect and enhance the connection between the cables and the second terminal, the cable connector 160 further includes an insulation cover 169 as shown by FIG. 9, which is a schematic diagram showing an insulation cover is assembled into a cable connector. The insulation cover 169 covers a place nearby the connection between the cables 168 and the second terminals 164.

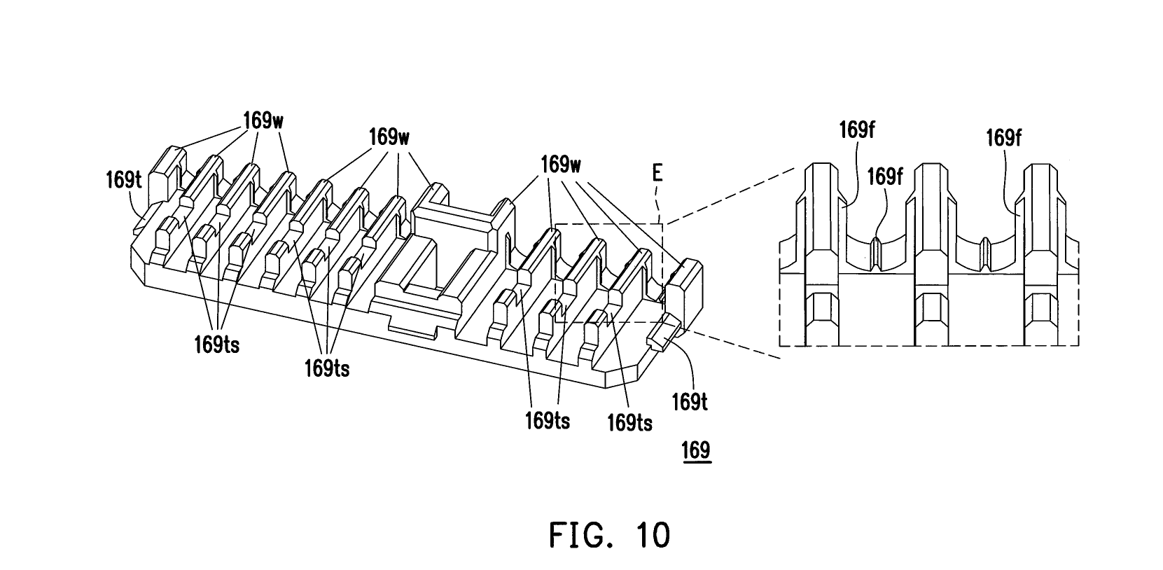

FIG. 10 is a 3-dimensional schematic diagram of an insulation cover according to an embodiment of the present invention.

Referring to FIGS. 9 and 10, the cables herein are common ones, in which, unlike the described above, the cables are not a differential-signal wire set composed of three cables. However if the cables are differential-signal wire sets, the lengthwise walls 169w of the insulation cover 169 and the shape thereof should be accordingly modified so as to better clamp the cables.

The insulation cover 169 has a plurality of lengthwise walls 169w disposed correspondingly to the shapes of the cables 168. The lengthwise walls 169w partition the cables 168 in the cable connector 160 and partition adjacent second terminals 164 in the cable connector 160, so that the cables 168 are clamped by assembling the insulation cover 169 and the second insulation base 162.

In the present invention, the lengthwise walls 169w of the insulation cover 169 are disposed correspondingly to the shapes of the cables 168 to be clamped. For example, if the cables 168 are a bundle of single wires, the lengthwise walls 169w of the insulation cover 169 are designed as shown by FIG. 10; if the cables 168 are composed of differential-signal wire sets (as shown by FIG. 7, the cables are respectively in a bundle of three wires), the shapes of the lengthwise walls 169w would be accordingly modified. In short, the lengthwise walls 169w of the insulation cover 169 are disposed according to the shapes of the cables 168 so that the cables can be clamped by means of assembling the insulation cover and the second insulation base, which falls in the design idea of the insulation cover and the claims in the invention.

The insulation cover 169 is assembled into the second insulation base 162 by fastening each other. For example, the insulation cover 169 has at least one cover tenon 169t and the second insulation base 162 has a fastening portion 162h (for example, fastening hole shown by FIG. 9), in which the fastening portion 162h is located at a place corresponding to the cover tenon 169t so that the cover tenon 169t and the fastening portion 162h can be fastened by each other.

In order to further enhance the connection between the cables 168 and the second terminals 164, each of the lengthwise walls 169w has a transverse groove 169ts in the invention. The transverse grooves 169ts form accommodation spaces of glue; i.e., when assembling the cable connector 160, in the step of assembling-into the cables 168, the transverse grooves 169ts can accommodate the protective glue, so that after the protective glue is cured, the held strength between the cables 168 and the second terminals 164 are enhanced.

In addition, at least one flange 169f is formed at one side of the lengthwise walls 169w (referring to a locally enlarged portion E in FIG. 10) so that the cables 168 can be clamped further.

### First and Second Metallic Covers

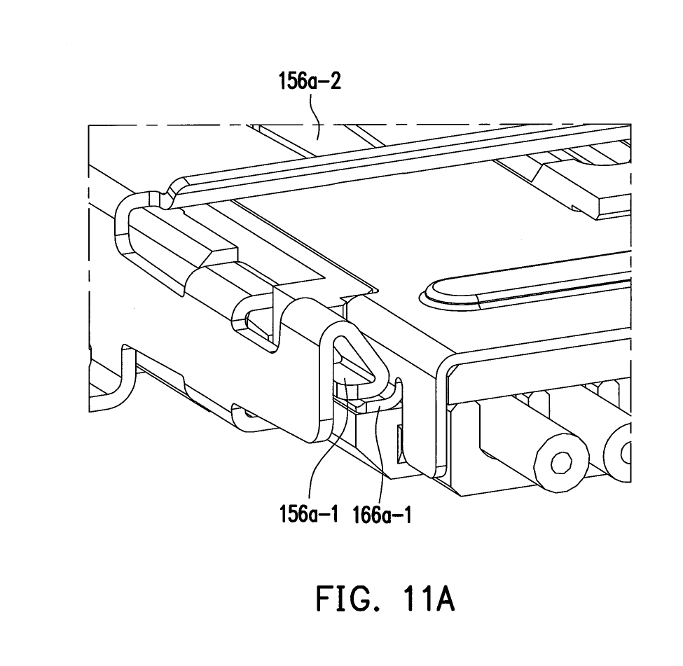

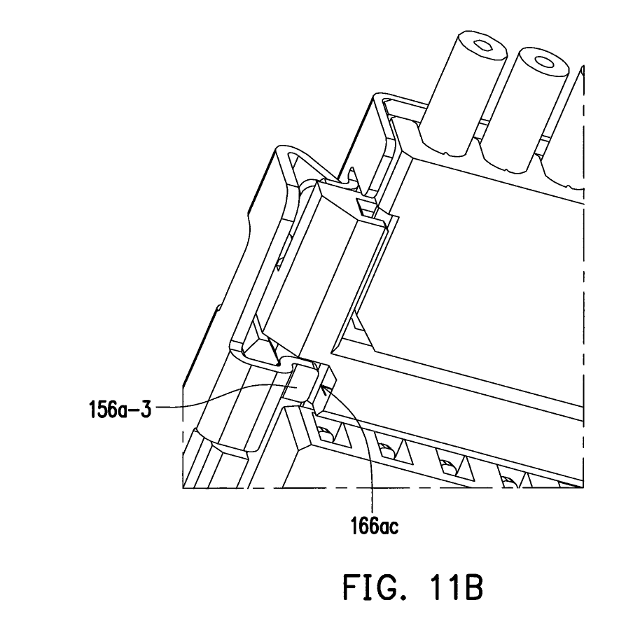

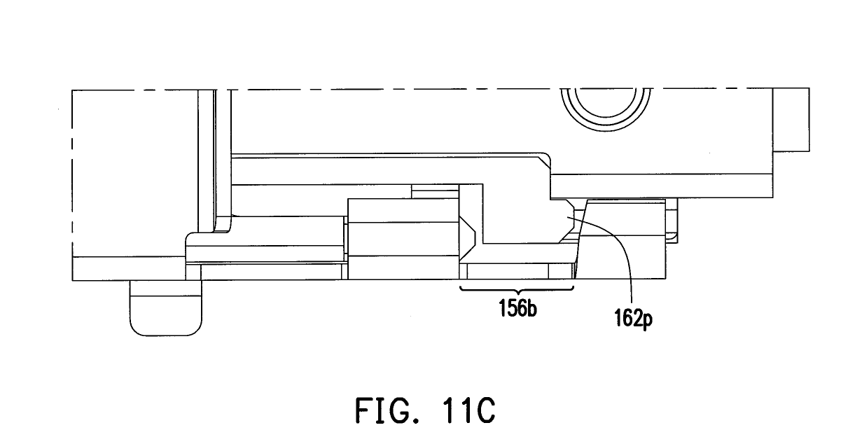

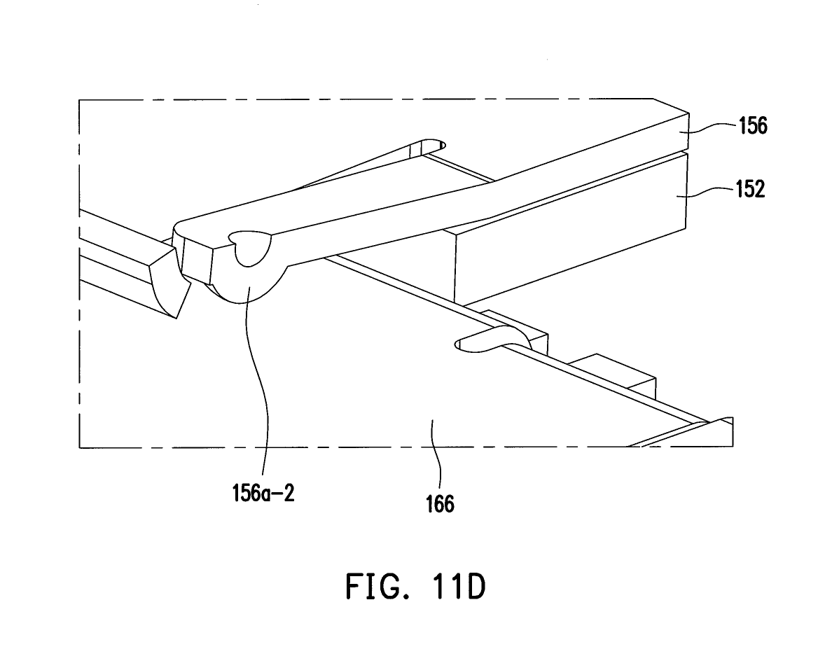

In order to enhance electromagnetic shielding function, the first metallic shell 156 in the present invention has at least one first contacting portion 156a (156a-1 and 156a-2, referring to locally enlarged portions C and D in FIG. 6) and the second metallic shell 166 has at least one second contacting portion 166a (FIG. 7). The positions of the first contacting portions 156a are corresponding to the positions of the second contacting portions 166a and they are contacted each other (i.e., an electrical contact, referring to FIG. 11A later). In this way, the first metallic shell 156 and the second metallic shell 166 together form an electromagnetic shielding structure S. The contacting portions 156a and 166a can also help the holding between the board-side connector and the cable connector.

According to the invention, the positions of the contacting portions are not critical, in which the important is the positions of the first contacting portions and the second contacting portions must be corresponding to each other. In addition, the structures and the positions of the contacting portions can be designed for achieving a lower overall height.

The details of the contacting portions are described in follows.

### First and Second Contacting Portion

The positions and implementation of the contacting portions are depicted through an example, which the present invention is not limited to, and they can have various modifications following the idea of the present invention.

For example, the first contacting portions 156a of the first metallic shell 156 are located at both sides, an upper side, one of the above-mentioned positions or other positions of the first metallic shell 156, while the positions of the second contacting portions 166a are corresponding to the positions of the first contacting portions 156a.

FIGS. 11A-11C are locally enlarged diagrams in different angles of view of part A in FIG. 3, and FIG. 11D is a locally enlarged diagram of part B in FIG. 3. Referring to FIGS. 11-11C, in which FIG. 11A is an oblique-top view from the upper-left side, FIG. 11B is an oblique-down view from the lower-left side and FIG. 11C is a top view from the right-upper side.

Referring to FIGS. 11A-11C, 6 and 7, the first contacting portions 156a include portions, such as 156a-1, formed by bending partial of a plurality of the first metallic shell 156 and at least one elastic plate, such as 156a-2, formed by portions of the first metallic shell 156. The first contacting portions 156a can be respectively a metallic protrusive point, a metallic protrusive line, a metallic protrusive surface or a combination of the above-mentioned elements.

FIG. 11D is a locally enlarged portion B in FIG. 3.

The detail of the elastic plates 156a-2 can be referred to FIG. 11D. In FIG. 11D, the partial first insulation base 152 and first metallic shell 156 are shown in cross-sectioned view to better explain the contacts between the elastic plates 156a-2 and the second metallic shell 166. In the embodiment, the first contacting portions 156a (156a-2) are elastic plates and respectively disposed at an upper side of the first metallic shell 156 so that the second metallic shell 166 can contact the elastic plates 156a-2 at the corresponding upper side.

### Upper Position-Limitation Portion

As shown by FIG. 11A, for example, the first metallic shell 156 at both sides thereof is bent to respectively form two first contacting portions 156a-1, in which the portions for leaning (no matter a point, a line, a surface or a combination of the above-mentioned elements) are downwards by bending. The two portions 156a-1 can further limit the upward moving of the second contacting portions 166a-1 of the second metallic shell 166 and thereby serve as an upper position-limitation portion. Thus, the portions 156a-1 in the first contacting portions 156a are not only used to make the first metallic shell 156 and the second metallic shell 166 connected by each other to form an electromagnetic shielding structure, but also provide an upper position-limitation function.

### Lower Position-Limitation Portion

Similarly to the described above, shown by FIG. 11B, the portions for leaning of the first contacting portions 156a-3 (no matter a point, a line, a surface or a combination of the above-mentioned elements) can be alternatively upwards by bending and a plurality of recesses 166ac are respectively formed at the corresponding positions of the second insulation base 162, for example, formed at both sides of the bottom thereof, which can further limit the downward moving of the second insulation base 162 and thereby serve as a lower position-limitation portion.

In FIG. 11B, the lower position-limitation function is achieved by the leaning action between the first contacting portions 156a-3 of the first metallic shell 156 and the second insulation base 162. The lower position-limitation function can be achieved by the leaning action between each pair of the contacting portions of the first metallic shell 156 and the second metallic shell 166 as well, in which the second contacting portions 166a are disposed correspondingly to the first contacting portions 156a. The second contacting portions 166a include a plurality of portions (for example, 166a-1) formed by bending partial of the second metallic shell 166 and can be respectively a metallic protrusive point, a metallic protrusive line, a metallic protrusive surface or a combination of the above-mentioned elements.

By disposing the upper position-limitation portions and the lower position-limitation portions, the board-side connector and the board-side connector are held by each other and the connectors can avoid an over-press. It is allowed only one of the upper position-limitation portion and the lower position-limitation portion is employed, or both of them are employed, or they are appropriately laid out according to design requirement, or they are omitted.

According to the invention, the important is the positions of the first contacting portions and the second contacting portions should be corresponding to each other so as to lean against each other, while the contact between the two contacting portions is not limited, which can be point contact, line contact, surface contact or a combination of the above-mentioned contact forms.

### Front-Rear Position-Limitation Portion

As shown by FIG. 11C, the first metallic shell 156 can further have a front-rear position-limitation portion 156b (also referring to FIG. 6). The front-rear position-limitation portion 156b can be implemented by that, for example, at at least one side of both sides of the first metallic shell 156, a gap is formed between at least two metallic bent portions and the second insulation base 162 has a position-limitation protrusive portion 162p corresponding to the position of the gap, in which the position-limitation protrusive portion 162p can be accommodated in the front-rear position-limitation portion 156b so as to limit the front-rear moving of the second connector 160.

### Combo Junction

As described above, the invention can uses the assembly of the board-side connector 150 and the cable connector 160 to make the circuit board connect various devices through the cables 168 with a junction in various specifications of the board-side connector 150. For example, it is connected to an SATA HDD, an SATA ODD, a USB3.0 transmission interface or a USB2.0/eSATA combo transmission interface and the like.

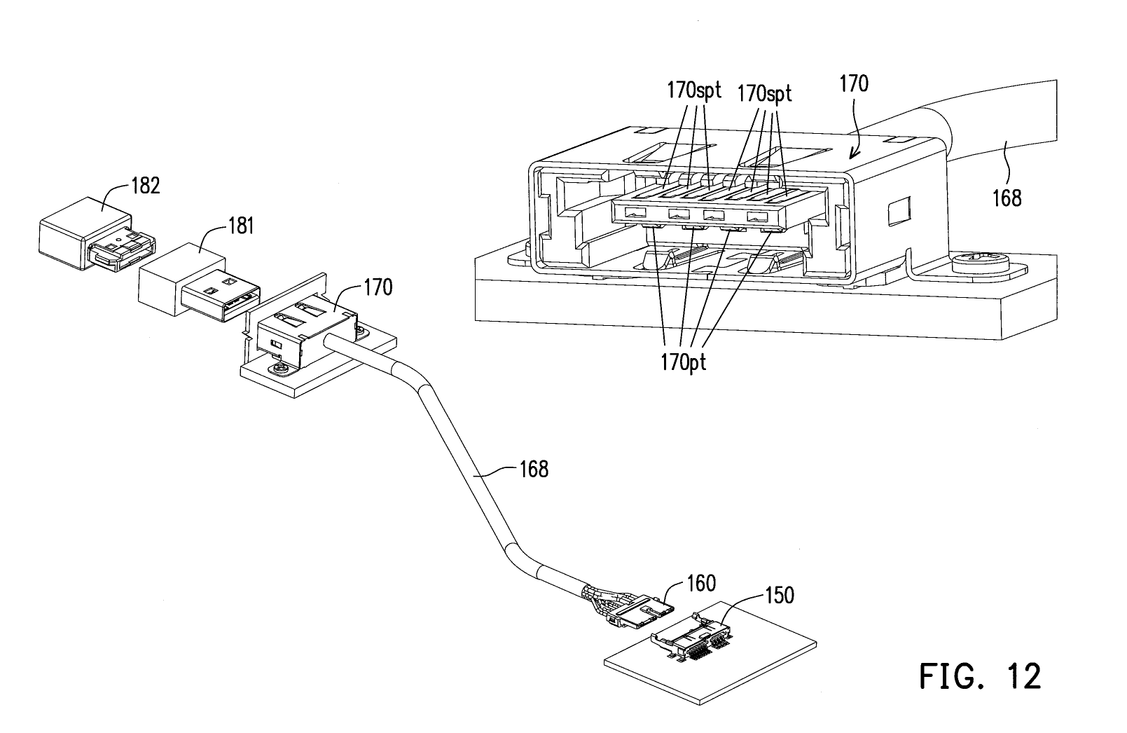

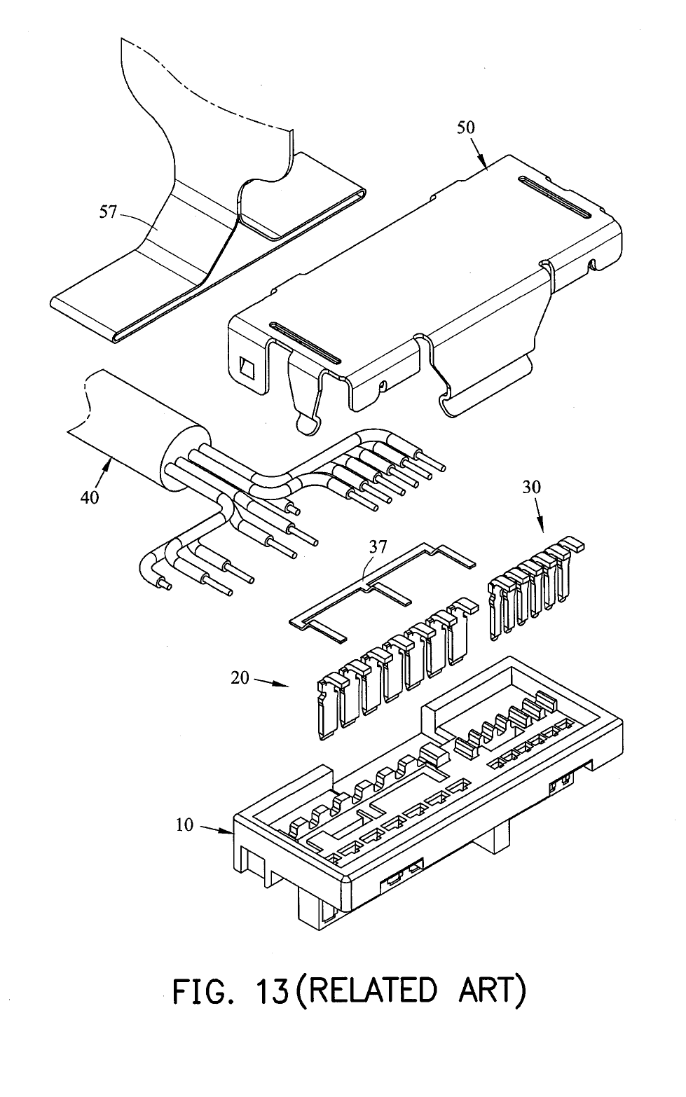

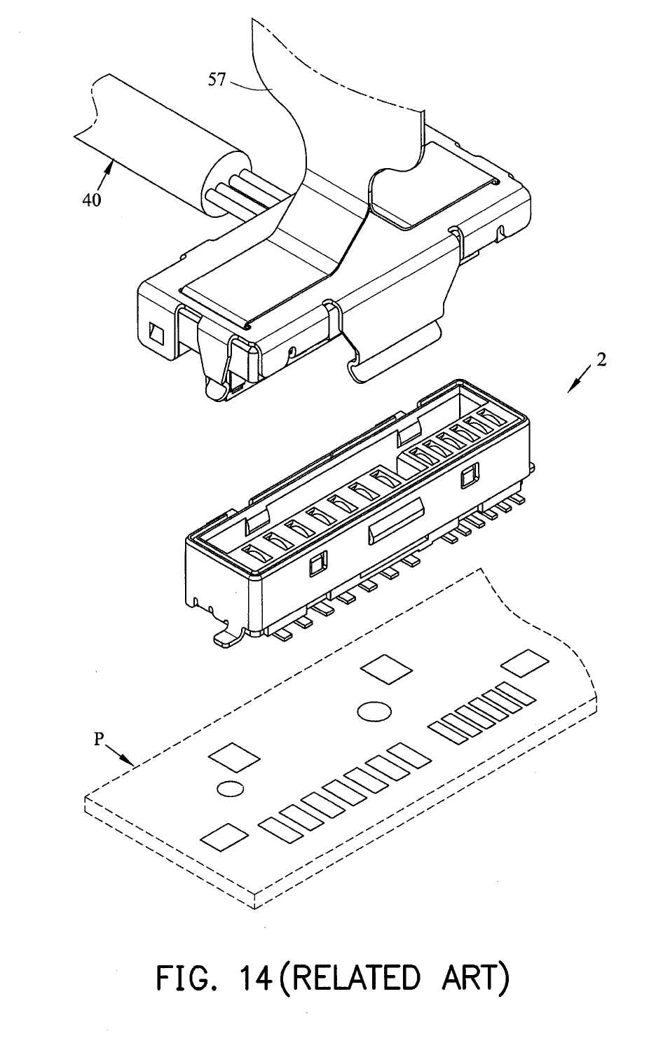

FIG. 12 is a schematic diagram of a connector assembly accompanied with a combo junction according to an embodiment of the present invention. Referring to FIG. 12, the invention can further allow connecting a combo junction 170 at an end of the cables 168. The combo junction 170 has power/low-speed signal terminals 170pt and high-speed terminals 170spt, and the specifications of the combo junction 170 include at least one of SATA specification, USB3.0 specification, USB2.0/eSATA combo specification or a combination of the above-mentioned specifications.

Since the electronic signals transmission content between the circuit board and other electronic devices can roughly be divided into power signal, low-speed signal and high-speed signal, so that the structure herein, after considering several common pin specifications and predetermined expansible margin, is preferably a universal design and the combo junction 170 has a universal structure. As a result, as long as the terminals number of the combo junction 170, the terminals numbers of the board-side connector and the terminals number of the cable connector (the terminals numbers of the first terminals and the second terminals) and the cable number are greater than the terminals number of the electronic device to be connected, a universal connection effect can be achieved by an appropriate connection layout (for example, connecting the cable/cables to the corresponding terminal/terminals).

The above-mentioned design makes the connector assembly 100 and the combo junction 170 of the invention universally used in as many specifications as possible.

One end of power/low-speed signal terminals 170pt and high-speed terminal 170spt are electrically connected to the cables 168 of the cable connector 160 and then respectively electrically connected to the power/low-speed signal terminal 154pt and the high-speed terminal 154spt of the first terminals 154 through the cables 168.

Moreover, the cables 168 of the cable connector 160 are connected to an electronic device in various specifications through the combo junction 170. In FIG. 12, the junction which the cables 168 are to be connected to is, for example, a USB2.0 junction 181 or an eSATA junction 182. According to the invention, as long as the devices are electronic devices with power/low-speed signal or high-speed signal, the connector assembly and the combo junction can be used therein.

### Width and Pitch of Terminals

The invention has taken that into consideration a power transmission prefers using wide path. In this regard, the width and pitch of the power/low-speed signal terminal 154pt among the first terminals 154 are greater than the width and pitch of the high-speed terminal 154spt; and the width and pitch of the power/low-speed signal terminal 164pt among the second terminals 164 are greater than the width and pitch of the high-speed terminal 164spt.

The above-mentioned feature is different from the common design of the current terminals. In the prior art, both the common power/low-speed signal terminal and high-speed terminal have the same width and pitch, and even in some designs, the width and pitch of the power/low-speed signal terminal are less than the width and pitch of the high-speed terminal. In short, the design idea of the invention that the width and pitch of the power/low-speed signal terminal are greater than the width and pitch of the high-speed terminal is novel and thereby the present invention can provide better electrical performance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A connector assembly, comprising a board-side connector suitable to be fixed onto a circuit board and a cable connector suitable to assist the circuit board and other devices for electronic signals transmission, wherein the board-side connector has an obliquely guiding path for the cable connector to be obliquely inserted and assembled into the board-side connector, the board-side connector has a first metallic shell, the cable connector has a second metallic shell, the first metallic shell and the second metallic shell are contacted each other to form an electromagnetic shielding structure, and the board-side connector and the cable connector are held by each other.

2. The connector assembly as claimed in claim 1, wherein the cable connector has a plurality of cables and a plurality of terminals slightly in plate-shape, the terminals slightly in plate-shape are disposed in the cable connector slightly in co-plane way and the cables are respectively electrically connected to the terminals, wherein the board-side connector has a plurality of first terminals which comprise at least one power/low-speed signal terminal and at least one high-speed terminal, the cable connector has a plurality of second terminals respectively electrically connected to the power/low-speed signal terminal and the high-speed terminal of the board-side connector, the second terminals of the cable connector are electrically connected to the cables, and the cables are suitable to be connected to devices compatible with specifications of SATA, USB3.0, USB2.0 or eSATA.

3. The connector assembly as claimed in claim 1, wherein the cable connector has a second insulation base, a plurality of second terminals, a plurality of cables and a second metallic shell, wherein the second insulation base has a second foolproof structure and a plurality of second slots, the second terminals are slightly in plate-shape and are disposed at the second slots slightly in co-plane way; the cables are electrically connected to the second terminals; the second metallic shell encloses a part of the second insulation base and exposes out the second terminals; the second foolproof structure has a lengthwise rib or a lengthwise recess, and the second metallic shell of the cable connector has at least one second contacting portion for electrically connecting the board-side connector so as to form an electromagnetic shielding structure.

4. A connector, which is a board-side connector comprising:
a first insulation base, having a first foolproof structure and a plurality of first slots;
a plurality of first terminals, respectively inserted at the first slots and respectively having a protrusive portion protruded from the first slots; and
a first metallic shell, enclosing a part of the first insulation base and exposing out the protrusive portions of the first terminals and portions of the first slots close to the protrusive portions, wherein the protrusive portions of the first terminals and the first metallic shell together form a guiding path, the first metallic shell of the board-side connector further has at least one first contacting portion for electrically connecting a cable connector to form an electromagnetic shielding structure, and the first foolproof structure comprises a lengthwise rib or a lengthwise recess.

5. A connector, comprising:
an insulation base, having a foolproof structure and a plurality of slots located at both sides of the foolproof structure; and
a power/low-speed signal terminal portion, having a plurality of power/low-speed signal terminals inserted at the slots at one side of the foolproof structure; and
a high-speed signal terminal portion, having a plurality of high-speed signal terminals inserted at the slots at the other side of the foolproof structure, wherein the width and pitch of the power/low-speed signal terminals are greater than the width and pitch of the high-speed signal terminals.

6. A connector assembly, comprising:
a first connector, having a first insulation base, a plurality of first terminals and a first metallic shell, wherein the first insulation base has a first foolproof structure and a plurality of first slots; the first terminals are respectively inserted at the first slots and the first terminals respectively have a protrusive portion protruded from the first slots; the first metallic shell encloses a part of the first insulation base and exposes out the protrusive portions of the first terminals and portions of the first slots close to the protrusive portions, the protrusive portions of the first terminals and the first metallic shell together form a guiding path, and the first metallic shell has at least one first contacting portion;
a second connector, having a second insulation base, a plurality of second terminals, a plurality of cables and a second metallic shell, wherein the second insulation base has a second foolproof structure which matches the first foolproof structure and a plurality of second slots; the second terminals are slightly in plate-shape and disposed at the second slots slightly in co-plane way; the cables are electrically connected to the second terminals; the second metallic shell encloses a part of the second insulation base and exposes out the second terminals and the second metallic shell has at least one second contacting portion;
wherein the second connector is obliquely inserted and assembled into the first connector through the guiding path, the first terminals are electrically connected to the second terminals, the first contacting portion and the second contacting portion are contacted each other, the first metallic shell and the second metallic shell together form an electromagnetic shielding structure and thereby the first connector and the second connector are held by each other.

7. The connector assembly as claimed in claim 6, wherein the first connector is a board-side connector and the second connector is a cable connector, wherein one of the first foolproof structure and the second foolproof structure is a lengthwise rib and the other one is a lengthwise recess for the lengthwise rib to be inserted into; the first contacting portion of the first metallic shell is located at both sides of the first metallic shell or at an upper side of the first metallic shell and a position of the second contacting portion is corresponding to a position of the first contacting portion.

8. The connector assembly as claimed in claim 6, wherein the first contacting portion is formed by bending a portion of the first metallic shell or is an elastic plate made with a portion of the first metallic shell, wherein the first contacting portion has a metallic protrusive point, a metallic protrusive line or a metallic protrusive surface; the second contacting portion is formed by bending a portion of the second metallic shell, wherein the second contacting portion has a metallic protrusive point, a metallic protrusive line or a metallic protrusive surface.

9. The connector assembly as claimed in claim 6, wherein a contact between the first contacting portion and the second contacting portion comprises point contact, line contact, surface contact or combination thereof; the first contacting portion has an upper position-limitation portion to limit an upward moving of the second contacting portion or a lower position-limitation portion to limit a downward moving of the second contacting portion.

10. The connector assembly as claimed in claim 6, wherein the first metallic shell has a front-rear position-limitation portion, the second insulation base has a position-limitation protrusive portion accommodated in the front-rear position-limitation portion so as to limit a front-rear moving of the second connector, and the front-rear position-limitation portion is located at both sides of the first metallic shell.

11. The connector assembly as claimed in claim 6, wherein the second connector has an insulation cover covering a place nearby a connection between the cables and the second terminals, wherein the insulation cover has a plurality of lengthwise walls disposed corresponding to a shape of the cables so that the cables are clapped by combing the insulation cover and the second insulation base, wherein each of the lengthwise walls has a transverse groove; the insulation cover has at least one cover tenon, the second insulation base has a fastening portion to fasten with the cover tenon, and the lengthwise walls have at least one flange at a side thereof.

12. The connector assembly as claimed in claim 6, wherein the first insulation base respectively has an extension arm at both sides of the first insulation base, wherein a thickness of the extension arm is gradually changed; the second insulation base has at least one base tenon and the second metallic shell has a fastening portion to fasten with the base tenon, wherein the base tenon is located at a front-end side of an assembling direction during assembling the second metallic shell into the second insulation base and the second metallic shell at the front-end side is round-corner shape.

13. The connector assembly as claimed in claim 7, wherein the first slots are located at both sides of the first foolproof structure, the first terminals are located at both sides of the first foolproof structure, wherein the first terminals at one of the both sides of the first foolproof structure are power/low-speed signal terminals and the first terminals at the other side of the first foolproof structure are high-speed terminals; a width and pitch of the power/low-speed signal terminals among the first terminals are greater than a width and pitch of the high-speed terminals.

14. The connector assembly as claimed in claim 7, wherein the second slots are located at both sides of the second foolproof structure, the second terminals are located at both sides of the second foolproof structure, wherein the second terminals at one of the both sides of the second foolproof structure are power/low-speed signal terminals and the second terminals at the other side of the second foolproof structure are high-speed terminals; a width and pitch of the power/low-speed signal terminals among the second terminals are greater than a width and pitch of the high-speed terminals.

15. The connector assembly as claimed in claim 7, wherein pin definitions of the power/low-speed signal terminals of the first terminals comprise all pin definitions of USB 2.0, pin definitions of SATA power terminal or pin definitions of eSATA power terminal, and pin definitions of the high-speed terminals of the first terminals comprise pin definitions of SATA signal terminal, USB 3.0 signal terminal or eSATA signal terminal; the cables have at least one pair of differential-signal wire sets, the cables are single-core wire or multi-cores wire, and the cables are suitable to be connected to devices compatible with specifications of SATA, USB3.0, USB2.0 or eSATA.

16. The connector assembly as claimed in claim 13, wherein the connector assembly has a combo junction, the combo junction has a plurality of power/low-speed signal terminals and a plurality of high-speed terminals, one end of the power/low-speed signal terminals and the high-speed terminals are electrically connected to the cables of the second connector, and then via the cables, respectively electrically connected to the power/low-speed signal terminal and the high-speed terminal of the first terminals, wherein the cables have at least one pair of differential-signal wire sets, the cables are single-cores wire or multi-cores wires, and a specification of the combo junction is SATA specification, USB3.0 specification, or USB2.0/eSATA combination specification.
